(19) United States
(12) Patent Application Publication
(10) Pub. No.: US 2026/0080291 A1
(43) Pub. Date: Mar. 19, 2026

(54) META-LEARNING-BASED QUANTUM STATE ESTIMATION METHOD AND SYSTEM

(71) Applicant: SAMSUNG SDS CO., LTD., Seoul (KR)

(72) Inventors: Jeong Woo JAE, Seoul (KR); Jeong Hoon Hong, Seoul (KR); Yeong Dae Kwon, Seoul (KR); Jin Ho Choo, Seoul (KR)

(73) Assignee: SAMSUNG SDS CO., LTD., Seoul (KR)

(21) Appl. No.: 19/229,567

(22) Filed: Jun. 5, 2025

(30) Foreign Application Priority Data
Sep. 13, 2024 (KR) 10-2024-0126117
Apr. 21, 2025 (KR) 10-2025-0051746

(51) Int. Cl. G06N 10/60

(52) U.S. Cl. CPC G06N 10/60

(57) ABSTRACT

There is provided a method for meta-learning-based quantum state estimation. The method may comprise: acquiring a first count indicating a number of times a first state is continuously output before a second state is first output as a result of inputting a quantum state into a quantum circuit having a first parameter; sampling parameters of the quantum circuit using results of reinforcement learning based on the first count; acquiring a second count indicating a number of times the first state is continuously output as a result of inputting the quantum state into the quantum circuit having the sampled parameters; updating the first parameter of the quantum circuit to a second parameter using the results of the reinforcement learning if the second count is less than a threshold count; and estimating the quantum state that has been input into the quantum circuit.

### CROSS-REFERENCE TO RELATED APPLICATION(S)

This application claims priority from Korean Patent Application No. 10-2024-0126117 filed on Sep. 13, 2024 and No. 10-2025-0051746 filed on Apr. 21, 2025 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a meta-learning-based quantum state estimation method and system, and more particularly, to a reinforcement-learning method for training quantum circuits to enhance the accuracy of quantum state estimation.

### 2. Description of the Related Art

A conventional approach widely used for learning quantum states is maximum likelihood estimation (MLE). However, MLE has a limitation in that the number of quantum measurements required increases exponentially as system dimensionality increases, making it practically applicable only to low-dimensional quantum systems. To address this issue, a single-shot measurement learning (SSML) technique has been recently proposed, which is a method for learning quantum states using quantum neural networks. SSML can reduce the learning error to below 10⁻⁵ and has the advantage of reducing the average error with respect to the number of shots used for learning down to the statistical limit. However, this method has been reported to be applicable mainly to quantum states of six or fewer dimensions, and since it uses a random search-based learning method, there is potential for performance improvement if advanced machine learning techniques such as deep reinforcement learning are adopted. In addition, the quantum neural network structures used for learning quantum states of five or more dimensions have physical implementation constraints on current quantum computers, necessitating research into models that are more feasible for practical implementation.

### SUMMARY

One objective of the present disclosure is to provide a method for training quantum circuits using reinforcement learning and an evolutionary strategy algorithm in order to improve the accuracy of quantum state estimation.

Another objective of the present disclosure is to provide a method that enhances practicality by training quantum circuits having a structure that is readily implementable on actual quantum computers.

Yet another objective of the present disclosure is to provide a method for increasing the shot efficiency required for training quantum circuits.

Still another objective of the present disclosure is to provide a method that enables estimation of an N+1-qubit quantum state using a model trained on an N-qubit quantum state.

The objectives of the present disclosure are not limited to those mentioned above, and other objectives not explicitly stated will be clearly understood by those skilled in the art based on the following description.

According to an aspect of the present disclosure, there is provided a method for meta-learning-based quantum state estimation. The method may be performed by a computing device, and may comprise: acquiring a first count indicating a number of times a first state is continuously output before a second state is first output as a result of inputting a quantum state into a quantum circuit having a first parameter; sampling parameters of the quantum circuit using results of reinforcement learning based on the first count; acquiring a second count indicating a number of times the first state is continuously output as a result of inputting the quantum state into the quantum circuit having the sampled parameters; updating the first parameter of the quantum circuit to a second parameter using the results of the reinforcement learning if the second count is less than a threshold count; and estimating the quantum state that has been input into the quantum circuit, by inputting the first state into the quantum circuit if the second count is equal to or greater than the threshold count.

In one embodiment, the results of the reinforcement learning based on the first count may comprise a first hyperparameter related to the sampling of the parameters and a second hyperparameter related to the updating of the first parameter, the first and second hyperparameters both being output by inputting the first count into an agent of the reinforcement learning.

In one embodiment, the sampling of the parameters may comprises: performing sampling a predetermined number of times according to a Gaussian distribution having a mean equal to the first parameter of the quantum circuit and a standard deviation equal to the first hyperparameter; and the second count may be acquired for each of the sampled parameters obtained by performing sampling the predetermined number of times.

In one embodiment, the method may further comprise: repeating the acquiring of the first count, the sampling of the parameters, the acquiring of the second count, the updating of the first parameter, and the estimating of the quantum state, wherein the repeating may be terminated if the second count becomes equal to or greater than the threshold count during the repeating.

In one embodiment, if a number of repetitions of the repeating is less than or equal to a preset number, the reinforcement learning may not be newly performed in the repeating, and the results of the reinforcement learning based on the first count corresponding to the quantum circuit having the first parameter may be reused, and if the number of repetitions of the repeating exceeds the preset number, the reinforcement learning may be newly performed in the repeating.

In one embodiment, the preset number may be determined based on a current number of repetitions of the repeating, and an upper limit and a lower limit of a preset repetition count.

In one embodiment, the method may further comprise: providing a penalty to the agent of the reinforcement learning if the second count is less than the threshold count during the repeating, and providing a reward to the agent of the reinforcement learning if the second count becomes equal to or greater than the threshold count during the repeating.

In one embodiment, the updating of the first parameter may comprise: applying gradient descent to an objective function related to the updating of the first parameter using the second hyperparameter as a learning rate.

In one embodiment, the estimating of the quantum state may comprise: calculating a fidelity between the quantum state and the first state for the quantum circuit.

According to another aspect of the present disclosure, there is provided a system for meta-learning-based quantum state estimation. The system may comprise: a processor; and a memory storing instructions, wherein the instructions, when executed by the processor, may cause the processor to: acquire a first count indicating a number of times a first state is continuously output before a second state is first output as a result of inputting a quantum state into a quantum circuit having a first parameter; sample parameters of the quantum circuit using results of reinforcement learning based on the first count; acquire a second count indicating a number of times the first state is continuously output as a result of inputting the quantum state into the quantum circuit having the sampled parameters; update the first parameter of the quantum circuit to a second parameter using the results of the reinforcement learning if the second count is less than a threshold count; and estimate the quantum state that has been input into the quantum circuit, by inputting the first state into the quantum circuit if the second count is equal to or greater than the threshold count.

In one embodiment, the results of the reinforcement learning based on the first count may comprise a first hyperparameter related to the sampling of the parameters and a second hyperparameter related to the updating of the first parameter, the first and second hyperparameters both being output by inputting the first count into an agent of the reinforcement learning.

In one embodiment, the sampling of the parameters may comprise: performing sampling a predetermined number of times according to a Gaussian distribution with a mean equal to the first parameter of the quantum circuit and a standard deviation equal to the first hyperparameter, and the second count may be acquired for each of the sampled parameters obtained by performing the sampling the predetermined number of times.

In one embodiment, the instructions, when executed by the processor, may further cause the processor to: repeat the acquiring of the first count, the sampling of the parameters, the acquiring of the second count, the updating of the first parameter, and the estimating of the quantum state, and if the second count becomes equal to or greater than the threshold count during the repeating, the repeating may be terminated.

In one embodiment, if a number of repetitions of the repeating is less than or equal to a preset number, the reinforcement learning may not be newly performed in the repeating, and the results of the reinforcement learning based on the first count corresponding to the quantum circuit having the first parameter may be reused, and if the number of repetitions of the repeating exceeds the preset number, the reinforcement learning may be newly performed in the repeating.

In one embodiment, the preset number may be determined based on a current number of repetitions of the repeating, and an upper limit and a lower limit of a preset repetition count.

In one embodiment, the instructions, when executed by the processor, may further cause the processor to: provide a penalty to the agent of the reinforcement learning if the second count is less than the threshold count during the repeating; and provide a reward to the agent of the reinforcement learning if the second count becomes equal to or greater than the threshold count during the repeating.

In one embodiment, the updating of the first parameter may comprise: applying gradient descent to an objective function related to the updating of the first parameter using the second hyperparameter as a learning rate.

In one embodiment, the estimating of the quantum state may comprise: calculating a fidelity between the quantum state and the first state for the quantum circuit.

According to still another aspect of the present disclosure, there is provided a non-transitory computer-readable medium storing a computer program. The computer program, when executed by a processor, may cause the processor to: acquire a first count indicating a number of times a first state is continuously output before a second state is first output as a result of inputting a quantum state into a quantum circuit having a first parameter; sample parameters of the quantum circuit using results of reinforcement learning based on the first count; acquire a second count indicating a number of times the first state is continuously output as a result of inputting the quantum state into the quantum circuit having the sampled parameters; update the first parameter of the quantum circuit to a second parameter using the results of the reinforcement learning if the second count is less than a threshold count; and estimate the quantum state that has been input into the quantum circuit, by inputting the first state into the quantum circuit if the second count is equal to or greater than the threshold count.

In one embodiment, the results of the reinforcement learning based on the first count may comprise a first hyperparameter related to the sampling of the parameters and a second hyperparameter related to the updating of the first parameter, the first and second hyperparameters both being output by inputting the first count into an agent of the reinforcement learning.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments in detail with reference to the accompanying drawings, in which:

FIG. 1 is a block diagram illustrating an exemplary configuration of an overall system according to some embodiments of the present disclosure;

FIG. 2 is a block diagram illustrating the concept of a meta-learning-based quantum state estimation method according to some embodiments of the present disclosure;

FIG. 3 is a flowchart illustrating a meta-learning-based quantum state estimation method according to some embodiments of the present disclosure;

FIG. 4 is a flowchart illustrating a meta-learning-based quantum state estimation method according to another embodiment of the present disclosure;

FIG. 5 is a flowchart illustrating a sampling step in FIGS. 3 and 4;

FIG. 6 is a flowchart illustrating an updating step in FIGS. 3 and 4;

FIG. 7 is a flowchart illustrating a quantum state estimation step in FIGS. 3 and 4;

FIG. 8 shows an algorithm for performing the meta-learning-based quantum state estimation methods of the present disclosure;

FIG. 9 presents graphs showing the effect of the meta-learning-based quantum state estimation method of the present disclosure according to the number of training iterations;

FIG. 10 is a graph showing the shot efficiency of the meta-learning-based quantum state estimation methods of the present disclosure according to target success count; and

FIG. 11 is a block diagram illustrating the hardware configuration of a computing device for performing the meta-learning-based quantum state estimation methods of the present disclosure.

### DETAILED DESCRIPTION

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In this specification, a quantum circuit refers to a computational model for processing quantum information and may be composed of multiple quantum gates. In a quantum circuit, qubits and quantum gates transform and process information. A quantum neural network (QNN) utilizes such a quantum circuit as a neural network, taking as input quantum states of arbitrary qubits (e.g., 1-qubit, 2-qubit, 3-qubit, etc.) and producing desired outputs. In the following description, the term “quantum circuit” will be understood to mean a quantum neural network.

Additionally, in this specification, a quantum state refers to the state of a qubit, which may be represented not merely as a classical 0 or 1, but as a superposition of those classical states. An N-qubit quantum state may be expressed as |ψ [symbol] . A quantum circuit U(θ) may receive the quantum state |ψ [symbol] as an input state and perform various quantum operations, allowing an output state U(θ)|ψ [symbol] to be measured. For example, the output state U(θ)|ψ [symbol] may be classified as a success state if the measurement result is 1, or a failure state if the measurement result is 0. In the following description, the term “output state” will be understood to refer to either a success or a failure state. In this specification, the term “success count” refers to the number of consecutive times a success state is output before a failure state occurs when a specific quantum state is input into a quantum circuit.

Furthermore, in this specification, the parameters of the quantum circuit U(θ) may refer to a rotation angle θ of the quantum gates that constitute the quantum circuit U(θ). The rotation angle θ of the quantum gates may be changed through the training of the quantum circuit U(θ) and may be adjusted such that a desired output state (i.e., a success state) is obtained. That is, in this specification, training a quantum circuit may refer to updating the parameters of the quantum circuit. For example, the quantum circuit may be trained until the success count reaches a sufficiently high level (e.g., until the success count reaches a target success count). In this specification, quantum state estimation may refer to inputting a quantum state into a quantum circuit whose parameters have been updated through training until the success count reaches the target success count.

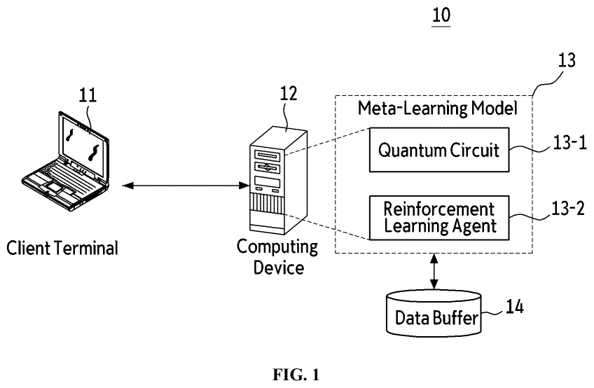

FIG. 1 is a block diagram illustrating an exemplary configuration of an overall system 10 according to some embodiments of the present disclosure. Referring to FIG. 1, the overall system 10 may include a client terminal 11, a computing device 12, and a data buffer 14. The computing device 12 may include a meta-learning model 13, which includes a quantum circuit 13-1 and a reinforcement learning agent 13-2.

The client terminal 11 may communicate with the computing device 12 to send a request to train the quantum circuit 13-1 so that the quantum circuit 13-1 accurately estimates a quantum state using the reinforcement learning agent 13-2 (e.g., by inputting a command or executing code for training the quantum circuit 13-1). For example, the client terminal 11 may include a smartphone, tablet PC, or laptop, but the present disclosure is not limited thereto, and the client terminal 11 may include any type of computing device equipped with computational and communication means.

The computing device 12 may receive the request sent from the client terminal 11 and train the quantum circuit 13-1 so that the quantum circuit 13-1 accurately estimates a quantum state. Training the quantum circuit 13-1 refers to updating the parameters of the quantum circuit 13-1 so that the success count obtained when an arbitrary quantum state is input reaches the target success count. Reinforcement learning by the reinforcement learning agent 13-2 may be performed to update the parameters of the quantum circuit 13-1.

A meta-learning-based quantum state estimation according to an embodiment of the present disclosure may be understood as a process in which the parameters of the quantum circuit 13-1 are updated through reinforcement learning by the reinforcement learning agent 13-2, and a quantum state is estimated using the quantum circuit 13-1 having the updated parameters.

The computing device 12 may be implemented using one or more physical servers included in a server farm based on cloud technology such as virtual machines. The specific configuration and operation of the computing device 12 will be described later with reference to FIG. 11.

The data buffer 14 may be a space for storing data output according to embodiments of the present disclosure (e.g., output states generated during the training of the quantum circuit 13-1, hyperparameters output through reinforcement learning, rewards of reinforcement learning, etc.). The reinforcement learning agent 13-2 may be trained using data randomly selected from the data buffer 14. Details on the hyperparameters output through reinforcement learning and the rewards of reinforcement learning will be described later.

The components depicted in FIG. 1 may communicate via a network. For example, the network may be implemented as any type of wired/wireless network such as a local area network (LAN), wide area network (WAN), mobile radio communication network, or Wireless Broadband Internet (WiBro).

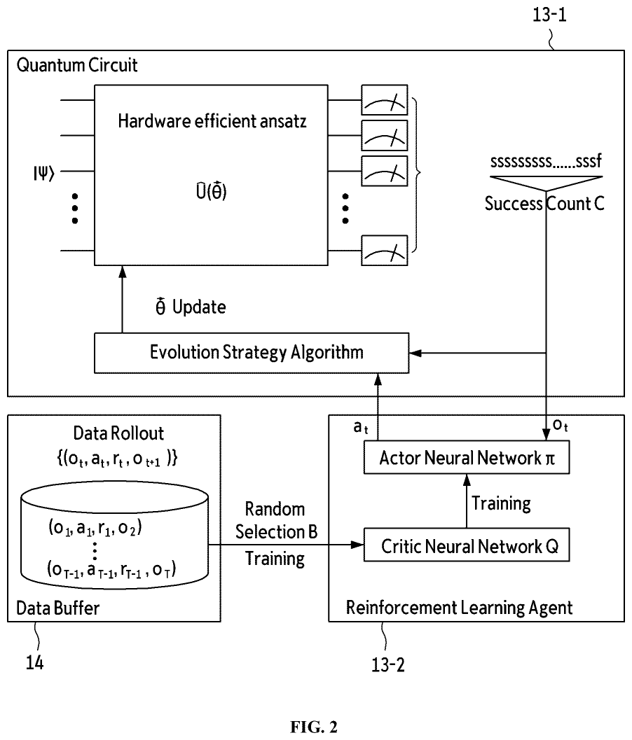

FIG. 2 is a block diagram illustrating the concept of a meta-learning-based quantum state estimation method according to some embodiments of the present disclosure. Embodiments related to meta-learning-based quantum state estimation will hereinafter be described in detail with reference to FIG. 2. Operations described in FIG. 2 will be understood as operations performed by the computing device 12 of FIG. 1.

The quantum circuit 13-1 may be implemented in a hardware-efficient ansatz (HEA) structure including multiple U3 gates and CNOT gates, but the present disclosure is not limited thereto. The quantum circuit 13-1 may also be implemented with other structures than the HEA structure.

Training the quantum circuit 13-1 according to an embodiment of the present disclosure is based on an evolution strategy (ES) algorithm. The ES algorithm, which is for optimizing a nonlinear function, includes sampling parameters according to a predetermined distribution (e.g., a Gaussian distribution), evaluating each sampled parameter with respect to an objective function J(θ) of the ES algorithm, and updating the parameter θ based on the results of the evaluation of each sampled parameter. For example, the objective function J(θ) may be defined by Equation 1 below.

$$J ( θ ) := \frac{1}{{C}_{T}} {E}_{θ ∼ p ( θ )} [ C ( θ ) ] {∇}_{θ} J ( θ ) := \frac{1}{{C}_{T} σ k} {\sum }_{i = 1}^{k} C ( θ + {σϵ}_{1} ) {ϵ}_{i} \qquad [ Equation l ]$$

Here, C_{T} is the value of the target success count and may serve to normalize the objective function J(θ) to a value between 0 and 1, and p(θ) represents a Gaussian distribution with a mean of θ and covariance of σ²I, wherein σ, which is the standard deviation of the Gaussian distribution and determines the sampling range around the parameter θ, is one of the hyperparameters output by the reinforcement learning agent 13-2.

For example, the computing device 12 may samples k parameters such as θ+σϵ₁, θ+σϵ₂, . . . , θ+σϵ_{K}. Then, the computing device 12 may obtain a success count for each of the k parameters by inputting a quantum state |ψ [symbol] into the quantum circuit 13-1 with the k parameters. If any one of the obtained success counts reaches the target success count, the training of the quantum circuit 13-1 (i.e., the parameter update for the quantum circuit 13-1) may be terminated. On the other hand, if none of the obtained success counts reaches the target success count, the parameter update for the quantum circuit 13-1 may be performed. For the parameter update, the computing device 12 may estimate a gradient ∇θJ(θ) of the objective function J(θ) for the k parameters as shown in Equation 2 below.

$${∇}_{θ} J ( θ ) := \frac{1}{{C}_{T} σ k} {\sum }_{i = 1}^{k} C ( θ + {σϵ}_{i} ) {ϵ}_{i} \qquad [ Equation 2 ]$$

If a parameter to be updated of the quantum circuit 13-1 at a current time t is θₜ, an updated parameter θₜ₊₁ at a time t+1 may be expressed by Equation 3 below.

$${θ}_{t + 1} ← {θ}_{t} + η {∇}_{θ} J ( θ ) \qquad [ Equation 3 ]$$

Equation 3 may represent a gradient descent method with a learning rate η. Similar to the standard deviation σ, the learning rate η is a hyperparameter output by the reinforcement learning agent 13-2. That is, whenever the quantum circuit 13-1 is trained, the hyperparameters σ and η may be output from the reinforcement learning agent 13-2, and the ES algorithm may be performed based on the output hyperparameters. Embodiments related to reinforcement learning by the reinforcement learning agent 13-2 will hereinafter be described.

The reinforcement learning agent 13-2 may include an actor neural network π and a critic neural network Q. The actor and critic neural networks π and Q may both be implemented as feed-forward neural networks based on fully connected layers. Specifically, the actor neural network π may learn a policy for determining the hyperparameter σ related to parameter sampling (see Equation 1) and the hyperparameter η related to parameter updating (see Equation 3), and the critic neural network Q may evaluate the value of the success state corresponding to each measurement result.

Referring to FIG. 2, the success count obtained by inputting the quantum state |ψ [symbol] into the quantum circuit 13-1 (corresponding to a measurement result oₜ at the time t) may be input into the actor neural network π, and the actor neural network π may output the hyperparameters σ and η as an action aₜ at the time t.

The objective of the reinforcement learning agent 13-2 is to complete the training of the quantum circuit 13-1 via the ES algorithm as quickly as possible. To this end, a reward or penalty may be given to the reinforcement learning agent 13-2 during the training of the quantum circuit 13-1. For example, if the training of the quantum circuit 13-1 is completed according to the hyperparameters σ and η output at the time t, a reward may be given (i.e., rₜ=0), and if the training is not completed, a penalty may be given (i.e., rₜ=−1). Assuming that the training of the quantum circuit 13-1 is completed at a time T_{H}, a cumulative reward Rₜ given to the reinforcement learning agent 13-2 may be expressed by Equation 4 below.

$${R}_{t} = {\sum }_{t}^{{T}_{H}} {r}_{t} = t - {T}_{H} \qquad [ Equation 4 ]$$

At an arbitrary time t, aₜ (i.e., the hyperparameters σ and η), rₜ, and oₜ (i.e., the success count obtained by inputting the quantum state |ψ [symbol] at the time t) may all be stored in the data buffer 14. That is, as depicted in FIG. 2, the data buffer 14 may store data ranging from (oₜ, a₁, r₁, o₂) to (o_{T-1}, a_{T-1}, r_{T-1}, o_{T}). The actor and critic neural networks π and Q may be trained by rolling out the data stored in the data buffer 14 and using randomly selected data (oₜ, aₜ, rₜ, oₜ₊₁).

That is, the actor and critic neural networks π and Q may be trained using an actor-critic algorithm in which data generation, actor network update, and critic network update are repeatedly performed. For example, a loss function loss_{actor} of the actor neural network π and a loss function loss_{critic} of the critic neural network Q may be expressed by Equations 5 and 6, respectively.

$${loss}_{actor} ( χ ) := {A}_{t} log {π}_{χ} ( {a}_{t} \vert {o}_{t} ) \qquad [ Equation 5 ]$$

$${loss}_{critic} ( ϕ ) := \frac{1}{2} {( {Q}_{ϕ} ( {o}_{t} ) - \frac{{R}_{t}}{{T}_{max}} )}^{2} \qquad [ Equation 6 ]$$

In Equation 5,

$${A}_{t} = {Q}_{ϕ} ( {o}_{t} ) - \frac{{R}_{t}}{{T}_{max}} .$$

The actor loss function loss_{actor} in Equation 5 may be optimized using gradient ascent, and the critic loss function loss_{critic} in Equation 6 may be optimized using gradient descent, thereby gradually improving the accuracy of the reinforcement learning agent 13-2. A detailed explanation of the actor-critic algorithm will be omitted.

As described above, when training the quantum circuit 13-1, parameter sampling and update may be performed based on reinforcement learning results, instead of randomly selecting the parameter θ to be updated. As a result, the number of shots (where a shot corresponds to one execution of the quantum circuit 13-1) required to reach the target success count may be reduced. That is, shot efficiency in training the quantum circuit 13-1 may be improved.

Meanwhile, in this embodiment, the action aₜ is described as being output from the reinforcement learning agent 13-2 whenever updating the parameter θ of the quantum circuit 13-1. However, in some embodiments, at the specific time t, the action aₜ of the reinforcement learning agent 13-2 may be reused without change at subsequent times t+1, t+2, t+3, . . . for a predefined number of repetitions. In other words, the hyperparameters σ and η output at the specific time t based on the success count of the quantum circuit 13-1 may be reused without change for parameter sampling and update at the subsequent times t+1, t+2, t+3, . . . for the predefined number of repetitions (i.e., the action may be repeated).

For example, a number Tᵣₑₚₑₜᵢₜᵢₒₙ of repetitions may be preset as indicated by Equation 7 below.

$${T}_{repetition} = max ( ⌈ ( \frac{{t}_{l} - {t}_{u}}{{T}_{max}} ) t + {t}_{u} ⌉ , {t}_{l} ) \qquad [ Equation 7 ]$$

Here, tᵤ and tₗ denote the lower limit and upper limit for the preset number Tᵣₑₚₑₜᵢₜᵢₒₙ, and Tₘₐₓ denotes an arbitrarily determined value (e.g., between 500 and 1000). That is, when t=0, the preset number Tᵣₑₚₑₜᵢₜᵢₒₙ may start from tᵤ and gradually decrease until it reaches tₗ. This means that in the early stage of training the quantum circuit 13-1, the output of the reinforcement learning agent 13-2 is reused repeatedly, while in the later stage, new outputs of the reinforcement learning agent 13-2 are gradually used. As a result, the overall training speed of the quantum circuit 13-1 may be improved.

When the training of the quantum circuit 13-1 is completed (i.e., when the success count of the quantum circuit 13-1 reaches the target success count for at least one of the k parameters), the computing device 12 may estimate the quantum state |ψ [symbol] by inputting a success state s into the quantum circuit 13-1 (i.e., U^{†}(θ)|s [symbol] where U^{†}(θ) indicates that the training of U(θ) is complete). This estimation is enabled by the fact that the purpose of training the quantum circuit 13-1 is to make the output quantum state U(θ)|ψ [symbol] transformed by the quantum circuit 13-1 match a basis state |s [symbol] corresponding to the success state s, and the parameter θ of the quantum circuit 13-1 is trained to increase the success count for that purpose.

As a metric for the accuracy of this estimation, the computing device 12 may calculate a fidelity f between the input quantum state and the success state as shown in Equation 8 below.

$$f := {\vert 〈 ψ \vert {U}^{†} ( θ ) \vert s 〉 \vert}^{2} \qquad [ Equation 8 ]$$

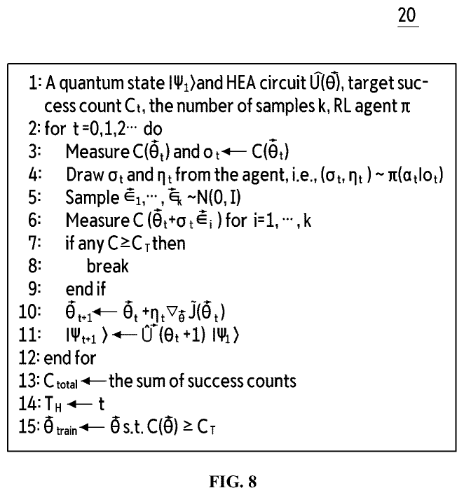

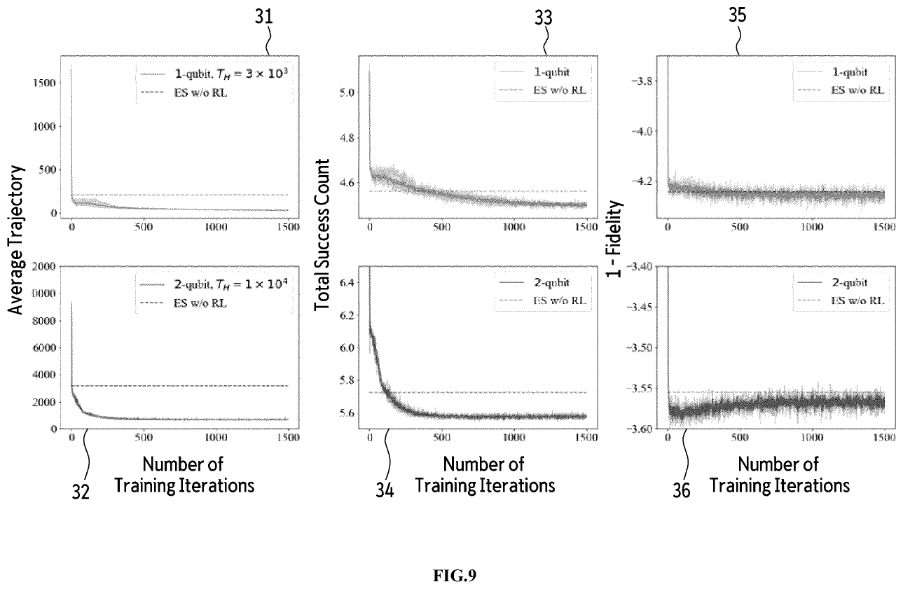

Meanwhile, an infidelity, which is a metric of inaccuracy, may be calculated as 1−f. Code implementing the meta-learning-based quantum state estimation method according to the embodiment of FIG. 2 will be described later with reference to FIG. 8.

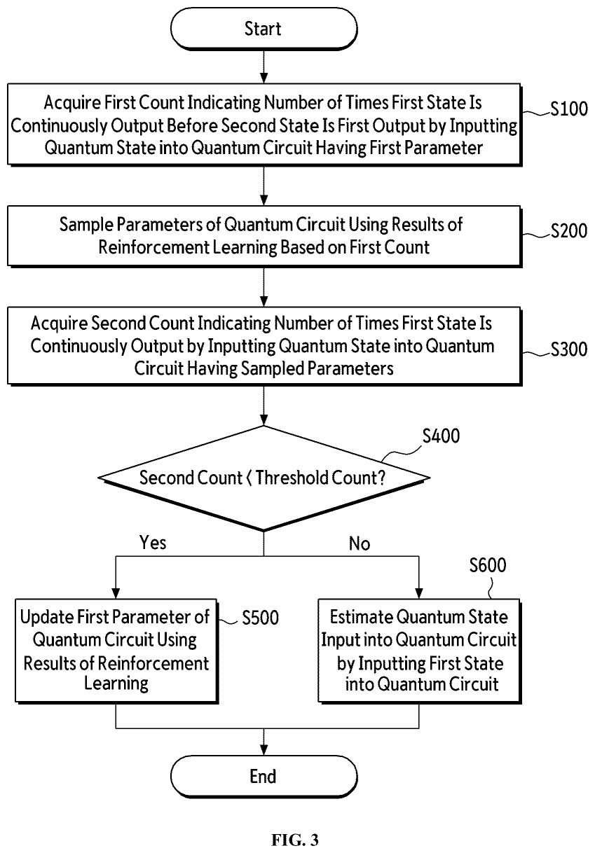

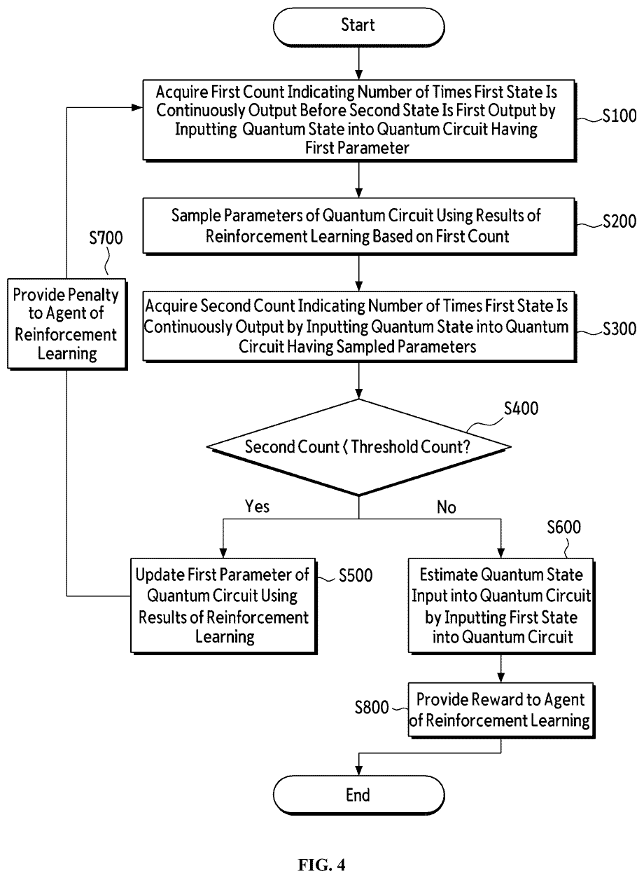

FIG. 3 is a flowchart illustrating a meta-learning-based quantum state estimation method according to an embodiment of the present disclosure. For reference, FIG. 3, and FIGS. 4 through 7 to be described later illustrate steps/operations performed by the computing device 12 of FIG. 1 or a computing device 500 of FIG. 11. Therefore, in the following description, when the subject of a specific step/operation is omitted, the step/operation may be understood as being performed by the computing device 12 of FIG. 1 or the computing device 500 of FIG. 11.

In step S100, a first count (or success count), which indicates the number of times a first state (i.e., a success state) is continuously output before a second state (i.e., a failure state) is first output as a result of inputting a quantum state into a quantum circuit having a first parameter (e.g., θₜ) may be obtained. In step S200, parameters of the quantum circuit may be sampled using results of reinforcement learning based on the first count. Here, the results of reinforcement learning based on the first count may include a first hyperparameter σ related to parameter sampling and a second hyperparameter η related to parameter update, the first and second hyperparameters σ and η both being by inputting the first count into a reinforcement learning agent.

In step S300, a second count (i.e., the success count of the quantum circuit having the sampled parameters), indicating the number of times the first state is continuously output as a result of inputting the quantum state into the quantum circuit having the sampled parameters, may be obtained. In step S400, it may be determined whether the second count is less than a threshold count (i.e., the target success count). If the second count is less than the threshold count (i.e., the target success count has not been reached), in step S500, the first parameter of the quantum circuit may be updated to a second parameter (e.g., θₜ₊₁) using the results of the reinforcement learning. Conversely, if the second count is equal to or greater than the threshold count (i.e., the target success count has been reached), in step S600, the first state may be input into the quantum circuit, and the input quantum state may be estimated.

FIG. 4 is a flowchart illustrating a meta-learning-based quantum state estimation method according to another embodiment of the present disclosure. Referring to FIG. 4, after the first parameter is updated to the second parameter in step S500, steps S100 through S600 may be repeated for the quantum circuit having the second parameter. During this process, if the second count becomes equal to or greater than the threshold count, the repetition of steps S100 through S600 may be terminated.

While steps S100 through S600 are being repeated, if the second count is less than the threshold count, in step S700, a penalty may be given to the reinforcement learning agent. Conversely, if the second count becomes equal to or greater than the threshold count, in step S800, a reward may be given to the reinforcement learning agent.

In some embodiments, if the number of repetitions of steps S100 through S600 is less than or equal to a preset number, reinforcement learning may not be newly performed, and the results of reinforcement learning based on the success count corresponding to the quantum circuit having the initial first parameter may be repeatedly used. If the number of repetitions of steps S100 through S600 exceeds the preset number, reinforcement learning may be newly performed. The preset number may be determined based on the current number of repetitions of steps S100 through S600, and the upper and lower limits for a preset repetition count, as expressed in Equation 7.

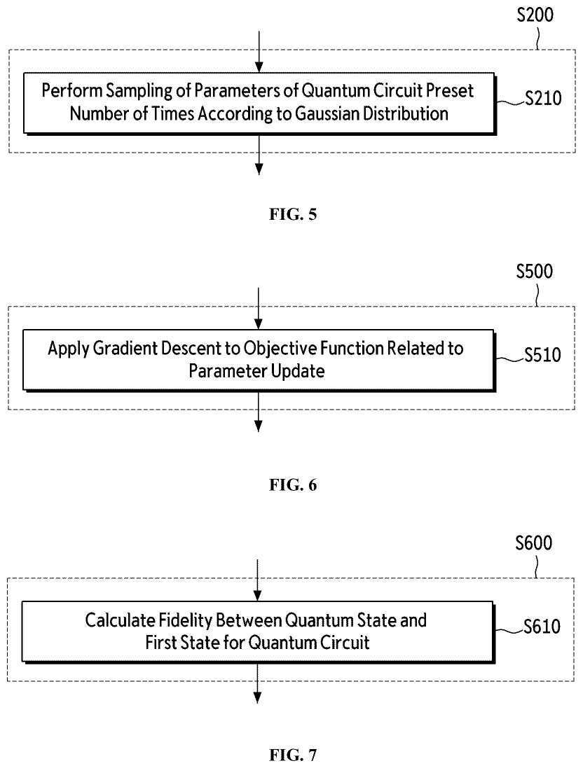

FIG. 5 is a detailed flowchart illustrating the sampling step (i.e., step S200) in FIGS. 3 and 4. Referring to FIG. 5, in step S210, sampling may be performed on the quantum circuit a predetermined number of times according to a Gaussian distribution with a mean of θ and a standard deviation of the first hyperparameter σ (i.e., a covariance of σ²I). The second count, which is the success count, may be obtained for each sampled parameter.

FIG. 6 is a detailed flowchart illustrating the updating step (i.e., step S500) in FIGS. 3 and 4. Referring to FIG. 6, in step S510, gradient descent using the second hyperparameter η as a learning rate may be applied to the objective function J(θ) related to updating the first parameter, e.g., the ES objective function described earlier with reference to FIG. 2, as shown in Equation 3 above.

FIG. 7 is a detailed flowchart illustrating the quantum state estimation step (i.e., step S600) in FIGS. 3 and 4. Referring to FIG. 7, in step S610, the fidelity between the quantum state and the first state (i.e., the success state s) for the quantum circuit may be calculated as shown in Equation 8 above.

FIG. 8 shows an algorithm for performing the meta-learning-based quantum state estimation methods of the present disclosure. Referring to FIG. 8, at a time t (t=0, 1, 2, . . . ), a success count C(θₜ) of a quantum circuit having a parameter θₜ may be measured, thereby obtaining a measurement result oₜ. A reinforcement learning agent π may receive the measurement result of as input and output hyperparameters σₜ and ηₜ as an action aₜ. Then, k parameters may be sampled according to a Gaussian distribution N(0, I), and a success count C(θt+σtϵi) of the quantum circuit having each sampled parameter θₜ+σₜϵᵢ may be obtained for i=1, . . . , k.

If any of the obtained success counts is equal to or greater than a target success count C_{T} (i.e., any C≥C_{T}), the training of the quantum circuit may be terminated (corresponding to the “break” in the for loop). Then, the total success count (i.e., the total number of shots used for training) may be stored as Cₜₒₜₐₗ, the time t at which the training is completed (i.e., the number of iterations of the ES algorithm) may be stored as T_{H}, and the trained parameter of the quantum circuit may be stored as θₜᵣₐᵢₙ. Cₜₒₜₐₗ, T_{H}, and θₜᵣₐᵢₙ may be stored (e.g., in the data buffer 14) for future evaluation. For example, in an actual experiment on a quantum computer, execution time is expected to be proportional to Cₜₒₜₐₗ.

On the other hand, if there is no C(θₜ+σₜϵᵢ) that reaches the target success count C_{T}, the parameter θₜ may be updated to θₜ₊₁ using gradient descent with the hyperparameter ηₜ as the learning rate, and the above process may be repeated for a time t+1.

FIG. 9 presents graphs showing the effect of the meta-learning-based quantum state estimation methods of the present disclosure based on the number of training iterations. Referring to FIG. 9, dashed lines represent cases where the ES algorithm is performed without reinforcement learning, while solid lines represent cases where reinforcement learning is introduced along with the ES algorithm as in the embodiments of the present disclosure.

Referring first to graphs 31 and 32, based on T_{H}=3000, the application of meta-learning to 1-qubit and 2-qubit quantum states shows that the average trajectory (where the trajectory refers to the sequence of actions taken by the agent of the reinforcement learning) decreases with the number of training iterations, indicating that the learning speed increases over time.

Then, referring to graphs 33 and 34, based on C_{T}=10⁴, the values of Cₜₒₜₐₗ are shown to be 10^{4.48} for a 1-qubit quantum state and 10^{5.57} for a 2-qubit quantum state. That is, Cₜₒₜₐₗ decreases as training progresses.

Then, referring to graphs 35 and 36, similarly based on C_{T}=10⁴, the infidelity is calculated as 10^{4.23} for a 1-qubit quantum state and 10^{-3.57} for a 2-qubit quantum state. In other words, the estimation inaccuracy decreases as training progresses.

Therefore, referring to FIG. 9, it can be seen that introducing reinforcement learning according to the present disclosure (represented by the solid lines) leads to improvements in all metrics compared to when reinforcement learning is not introduced (represented by the dashed lines).

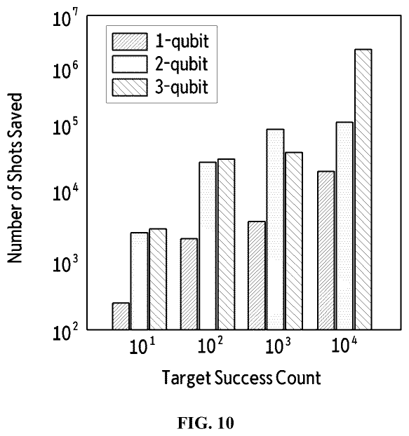

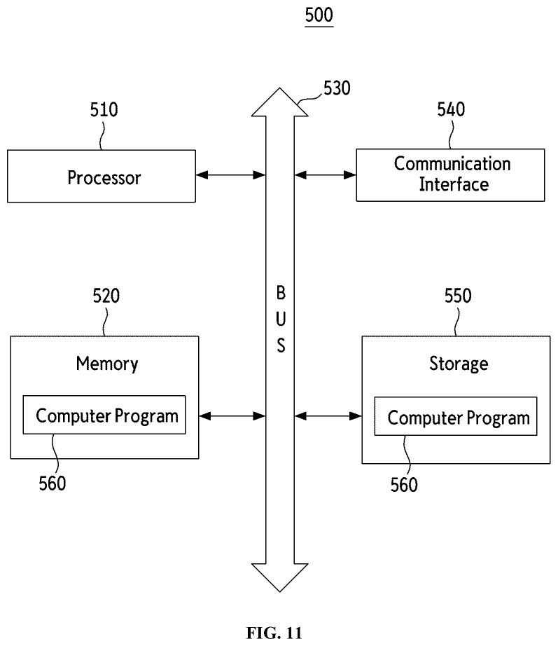

FIG. 10 is a graph showing the shot efficiency of the meta-learning-based quantum state estimation methods of the present disclosure according to target success count. It is assumed that a quantum circuit composed of one U3 gate was used for training with a 1-qubit quantum state, a quantum circuit composed of a one-layer HEA gate for training with a 2-qubit quantum state, and a quantum circuit composed of a five-layer HEA gate for training with a 3-qubit quantum state. Referring to FIG. 10, when C_{T}=10⁴, the number of shots required for training a quantum circuit may be reduced by more than 30,000 for a 1-qubit quantum state, more than 200,000 for a 2-qubit quantum state, and more than 2.8 million for a 3-qubit quantum state. This indicates that the higher the target success count C_{T}, the greater the benefit obtained from the embodiments of the present disclosure.

Furthermore, according to the embodiments of the present disclosure, a model trained using an N-qubit quantum state (i.e., a 2^{N}-dimensional quantum state) may also be applied to an N+1-qubit quantum state (i.e., a 2^{N+1}-dimensional quantum state). For example, referring to FIG. 10, a model trained using a 3-qubit quantum state may also be applied to estimate a 4-qubit quantum state. Specifically, if the number of layers of the HEA gates in the model trained with a 3-qubit quantum state is changed from five to ten, the model may also be applicable to a 4-qubit quantum state, as experimentally shown. This indicates that a model trained on an 8-dimensional quantum state can be used to estimate a 16-dimensional quantum state because according to the embodiments of the present disclosure, the reinforcement learning agent can learn the parameters of the ES algorithm regardless of the increase in the dimensionality of the quantum state.

FIG. 11 is a block diagram illustrating the hardware configuration of the computing device 500 including a language model according to an embodiment of the present disclosure.

Referring to FIG. 11, the computing device 500 may include at least one processor 510, a bus 530, a communication interface 540, a memory 520 that loads a computer program 560 executed by the processor 510, and a storage 550 that stores the computer program 560. However, FIG. 11 illustrates only components relevant to embodiments of the present disclosure. Accordingly, one of ordinary skill in the art may understand that the computing device 500 may include additional general-purpose components other than those illustrated in FIG. 11. That is, the computing device 500 may include various additional components beyond those illustrated in FIG. 11. Additionally, in some embodiments, the computing device 500 may be configured with some of the illustrated components omitted. Each component of the computing device 500 will hereinafter be described.

The processor 510 may control the overall operation of each component of the computing device 500. The processor 510 may include at least one of a Central Processing Unit (CPU), a Micro Processor Unit (MPU), a Micro Controller Unit (MCU), a Graphics Processing Unit (GPU), or any other type of processor well known in the technical field of the present disclosure. Additionally, the processor 510 may perform computation for executing at least one application or program for implementing operations/methods according to embodiments of the present disclosure. The computing device 500 may include one or more processors 510.

The memory 520 may store various data, commands, and/or information. The memory 520 may load the computer program 560 from the storage 550 to execute the operations/methods according to embodiments of the present disclosure. The memory 520 may be implemented as a volatile memory such as Random-Access Memory (RAM), but is not limited thereto.

The bus 530 may provide communication functionality between the components of the computing device 500. The bus 530 may be implemented as various types of buses, including an address bus, a data bus, or a control bus.

The communication interface 540 may support wired and wireless internet communication of the computing device 500. Additionally, the communication interface 540 may support various communication methods other than internet communication. To this end, the communication interface 540 may include a communication module well known in the technical field of the present disclosure.

The storage 550 may non-transiently store at least one computer program 560. The storage 550 may be implemented as a non-volatile memory such as Read-Only Memory (ROM), Erasable Programmable ROM (EPROM), Electrically Erasable Programmable ROM (EEPROM), flash memory, a hard disk, a removable disk, or any other type of computer-readable recording medium well known in the technical field of the present disclosure.

The computer program 560 may include one or more instructions that, when loaded into the memory 520, cause the processor 510 to perform the operations/methods according to embodiments of the present disclosure. That is, by executing the loaded instructions, the processor 510 may perform the operations/methods according to embodiments of the present disclosure.

For example, the computer program 560 may include instructions for performing the operations of: acquiring a first count indicating the number of times a first state (i.e., a success state) is continuously output before a second state (i.e., a failure state) is first output as a result of inputting a quantum state into a quantum circuit having a first parameter; sampling parameters of the quantum circuit using results of reinforcement learning based on the first count; acquiring a second count indicating the number of times the first state is continuously output as a result of inputting the quantum state into the quantum circuit having the sampled parameters; updating the first parameter of the quantum circuit to a second parameter using the results of the reinforcement learning if the second count is less than a threshold count; and estimating the quantum state that has been input into the quantum circuit, by inputting the first state into the quantum circuit if the second count is equal to or greater than the threshold count.

According to embodiments of the present disclosure, even highly entangled and complex quantum states can be estimated with high accuracy. In particular, the number of shots required for training a quantum circuit can be significantly reduced compared to methods in which parameters of the quantum circuit are randomly explored and updated. As a result, the accuracy related to quantum computer initialization and the precision of fine control of the quantum computer can be improved, thereby enhancing the performance of machine learning using a quantum computer.

Various embodiments and the effects thereof according to the present disclosure have been mentioned with reference to FIGS. 1 through 8. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A meta-learning-based quantum state estimation method performed by a computing device, comprising:
acquiring a first count indicating a number of times a first state is continuously output before a second state is first output as a result of inputting a quantum state into a quantum circuit having a first parameter;
sampling parameters of the quantum circuit using results of reinforcement learning based on the first count;
acquiring a second count indicating a number of times the first state is continuously output as a result of inputting the quantum state into the quantum circuit having the sampled parameters;
updating the first parameter of the quantum circuit to a second parameter using the results of the reinforcement learning if the second count is less than a threshold count; and
estimating the quantum state that has been input into the quantum circuit, by inputting the first state into the quantum circuit if the second count is equal to or greater than the threshold count.

2. The meta-learning-based quantum state estimation method of claim 1, wherein the results of the reinforcement learning based on the first count comprise a first hyperparameter related to the sampling of the parameters and a second hyperparameter related to the updating of the first parameter, the first and second hyperparameters both being output by inputting the first count into an agent of the reinforcement learning.

3. The meta-learning-based quantum state estimation method of claim 2, wherein
the sampling of the parameters comprises: performing sampling a predetermined number of times according to a Gaussian distribution having a mean equal to the first parameter of the quantum circuit and a standard deviation equal to the first hyperparameter; and
the second count is acquired for each of the sampled parameters obtained by performing sampling the predetermined number of times.

4. The meta-learning-based quantum state estimation method of claim 2, further comprising:
repeating the acquiring of the first count, the sampling of the parameters, the acquiring of the second count, the updating of the first parameter, and the estimating of the quantum state,
wherein the repeating is terminated if the second count becomes equal to or greater than the threshold count during the repeating.

5. The meta-learning-based quantum state estimation method of claim 4, wherein
if a number of repetitions of the repeating is less than or equal to a preset number, the reinforcement learning is not newly performed in the repeating, and the results of the reinforcement learning based on the first count corresponding to the quantum circuit having the first parameter are reused, and
if the number of repetitions of the repeating exceeds the preset number, the reinforcement learning is newly performed in the repeating.

6. The meta-learning-based quantum state estimation method of claim 5, wherein the preset number is determined based on a current number of repetitions of the repeating, and an upper limit and a lower limit of a preset repetition count.

7. The meta-learning-based quantum state estimation method of claim 4, further comprising:
providing a penalty to the agent of the reinforcement learning if the second count is less than the threshold count during the repeating, and
providing a reward to the agent of the reinforcement learning if the second count becomes equal to or greater than the threshold count during the repeating.

8. The meta-learning-based quantum state estimation method of claim 2, wherein the updating of the first parameter comprises: applying gradient descent to an objective function related to the updating of the first parameter using the second hyperparameter as a learning rate.

9. The meta-learning-based quantum state estimation method of claim 1, wherein the estimating of the quantum state comprises: calculating a fidelity between the quantum state and the first state for the quantum circuit.

10. A meta-learning-based quantum state estimation system comprising:
a processor; and
a memory storing instructions,
wherein the instructions, when executed by the processor, cause the processor to: acquire a first count indicating a number of times a first state is continuously output before a second state is first output as a result of inputting a quantum state into a quantum circuit having a first parameter; sample parameters of the quantum circuit using results of reinforcement learning based on the first count; acquire a second count indicating a number of times the first state is continuously output as a result of inputting the quantum state into the quantum circuit having the sampled parameters; update the first parameter of the quantum circuit to a second parameter using the results of the reinforcement learning if the second count is less than a threshold count; and estimate the quantum state that has been input into the quantum circuit, by inputting the first state into the quantum circuit if the second count is equal to or greater than the threshold count.

11. The meta-learning-based quantum state estimation system of claim 10, wherein the results of the reinforcement learning based on the first count comprise a first hyperparameter related to the sampling of the parameters and a second hyperparameter related to the updating of the first parameter, the first and second hyperparameters both being output by inputting the first count into an agent of the reinforcement learning.

12. The meta-learning-based quantum state estimation system of claim 11, wherein
the sampling of the parameters comprises: performing sampling a predetermined number of times according to a Gaussian distribution with a mean equal to the first parameter of the quantum circuit and a standard deviation equal to the first hyperparameter, and
the second count is acquired for each of the sampled parameters obtained by performing the sampling the predetermined number of times.

13. The meta-learning-based quantum state estimation system of claim 11, wherein
the instructions, when executed by the processor, further cause the processor to: repeat the acquiring of the first count, the sampling of the parameters, the acquiring of the second count, the updating of the first parameter, and the estimating of the quantum state, and
if the second count becomes equal to or greater than the threshold count during the repeating, the repeating is terminated.

14. The meta-learning-based quantum state estimation system of claim 13, wherein
if a number of repetitions of the repeating is less than or equal to a preset number, the reinforcement learning is not newly performed in the repeating, and the results of the reinforcement learning based on the first count corresponding to the quantum circuit having the first parameter are reused, and
if the number of repetitions of the repeating exceeds the preset number, the reinforcement learning is newly performed in the repeating.

15. The meta-learning-based quantum state estimation system of claim 14, wherein the preset number is determined based on a current number of repetitions of the repeating, and an upper limit and a lower limit of a preset repetition count.

16. The meta-learning-based quantum state estimation system of claim 13, wherein
the instructions, when executed by the processor, further cause the processor to: provide a penalty to the agent of the reinforcement learning if the second count is less than the threshold count during the repeating; and provide a reward to the agent of the reinforcement learning if the second count becomes equal to or greater than the threshold count during the repeating.

17. The meta-learning-based quantum state estimation system of claim 11, wherein the updating of the first parameter comprises: applying gradient descent to an objective function related to the updating of the first parameter using the second hyperparameter as a learning rate.

18. The meta-learning-based quantum state estimation system of claim 10, wherein the estimating of the quantum state comprises calculating a fidelity between the quantum state and the first state for the quantum circuit.

19. A non-transitory computer-readable medium storing a computer program,
wherein the computer program, when executed by a processor, causes the processor to: acquire a first count indicating a number of times a first state is continuously output before a second state is first output as a result of inputting a quantum state into a quantum circuit having a first parameter; sample parameters of the quantum circuit using results of reinforcement learning based on the first count; acquire a second count indicating a number of times the first state is continuously output as a result of inputting the quantum state into the quantum circuit having the sampled parameters; update the first parameter of the quantum circuit to a second parameter using the results of the reinforcement learning if the second count is less than a threshold count; and estimate the quantum state that has been input into the quantum circuit, by inputting the first state into the quantum circuit if the second count is equal to or greater than the threshold count.

20. The non-transitory computer-readable medium of claim 19, wherein the results of the reinforcement learning based on the first count comprise a first hyperparameter related to the sampling of the parameters and a second hyperparameter related to the updating of the first parameter, the first and second hyperparameters both being output by inputting the first count into an agent of the reinforcement learning.
